(19) United States
(12) Patent Application Publication
(10) Pub. No.: US 2011/0103293 A1
(43) Pub. Date: May 5, 2011

(54) INTERNET BASED PARTITIONING WIRELESS COMMUNICATION SYSTEM

(75) Inventors: Rick K. Gale, Warrenton, VA (US); Jeffrey M. Jugar, Ashburn, VA (US)

(73) Assignee: PARAGON COMMUNICATION SOLUTIONS, INC., Reston, VA (US)

(21) Appl. No.: 12/915,020

(22) Filed: Oct. 29, 2010

Related U.S. Application Data
(60) Provisional application No. 61/256,859, filed on Oct. 30, 2009.
(60) Provisional application No. 61/366,429, filed on Jul. 21, 2010.

(51) Int. Cl. H04W 4/00

(52) U.S. Cl. 370/315

(57) ABSTRACT

A portable and autonomous wireless communication system can be formed to provide streaming video from a data collection source to a plurality of subscribers in a location having little to no existing infrastructure. Using Internet Protocol (IP) based communication, live streaming video is provided over a wireless communication system to a control station allowing video and other data to be routed to multiple subscribers within a regional network. The control station can also act as an access point to the Internet or other wide area network that can then be used to transport the data to another remote location for distribution to other subscribers. As the event of interest moves, the control station and the network formed around that control station can be transported while network connectivity is maintained.

### RELATED APPLICATION

The present application relates to and claims the benefit of priority to U.S. Provisional Patent Application no. 61/256,859 filed Oct. 30, 2009, and U.S. Provisional Patent Application no: 61/366,429 filed Jul. 21, 2010, both of which are hereby incorporated by reference in their entirety for all purposes as if fully set forth herein.

### BACKGROUND OF THE INVENTION

1. Field of the Invention

Embodiments of the present invention relate, in general, to wireless communication and more particularly to Internet Protocol based partitioned wireless communication and streaming video.

2. Relevant Background

Just about every aspect of daily life is touched in one way or another by wireless technology; wireless technology being the ability to send signals and information through the air. Communicating across the street, across town, across the continent or across the world has all the earmarks of magic. All wireless transmissions piggyback information onto invisible waves through the air. The portion of the electromagnetic spectrum use to transmit information is called the radio frequency (RF) spectrum.

Examples of wireless technology and wireless communication include cellular telephones, remote controls, wireless computer networks, radio and television signals, walkie-talkies, and even garage door openers. All wireless transmissions share the common characteristic that a signal, now in wave form, travels through the air and is ultimately received by an antenna or aerial which sends it along to a receiver. While there are many different types of wireless communication systems cellular telephones and cellular communication networks are among the most ubiquitous. Cell phones networks are made up of the phones themselves; of individual cells and their associated stations, which communicate with the cell phones, and a variety of network hardware and software that handles internal processes for transferring calls and data within the network, and for transferring calls and data from the network to other networks and to the normal telephone system. One of the great successes of the modern cellular communication system is that to the average user the ability to make a telephone call on a cell phone is simple and easy where in reality it involves a great number of complex and intricate processes.

Central in the cellular telephone network design is the presence of a fixed base station. Base stations are made up of antennas, amplifiers, receivers, and transmitters and other hardware and software for sending and receiving signals as well as for converting RF waves to audio signals and other forms of data. Base stations typically include some kind of uplink to transmit calls back and forth from the cellular network to a mobile switching center. Calls are thereafter routed through a ground network to their destination be it another cell phone or landline. Such cellular networks include a wide variety of infrastructure such as mobile switching centers, home location registers, stored messaging servers and mobile subscriber units. Without the coordinated efforts of each of the various structured components wireless transmissions of our common everyday cellular communications cannot occur.

A glaring limitation to cellular communication is a need to establish line-of-sight contact between each cellular phone and a base station. A cellular communication network is made up of many overlapping cells each of which has a base station to serve cell phones within its own cell. As base stations are at fixed locations and a cellular telephone moves from one cell to the next, the telephone and the calls it is making must be handed off and managed by the mobile switching center. Through this management the location of each cell phone is always known or registered on the network.

Another form of wireless communication or wireless networking is referred to as IEEE 802.11 networks. In such a network an access point comprising a radio transmitter and receiver can interface to a wired network such as an Ethernet network so as to provide wireless devices access to the Internet. In such a network a computer which is referred to as a station acts as a bridge device between a wireless network and a wired network such as the Internet. Today even cellular telephones can access the Internet using such technology and communicate using what is known as Voice Over Internet Protocol (VOIP) technology.

While the technological advances and use of cellular communication devices have exploded challenges remain. For example, one side effect of having so many cellular telephones is the need to have numerous base stations. As more and more of these antenna farms are erected there has been a public outcry at their appearance and in some cases their interference with other aspects of the electromagnetic spectrum. Yet removing the fixed base station in a wireless network remains a challenge. Secondly, the mere volume of cellular telephone calls has, and continues to increase at an exponential rate. Once a novelty, cellular communication is now mainstream.

Another challenge is the ability to efficiently stream video over a wireless network. Streaming video is generally thought to include multimedia that is constantly received by, and normally presented to, an end-user with radio and television transmissions being rudimentary examples of streaming video. One growing application for streaming video is unmanned surveillance. Unmanned surveillance can include traffic cameras, security systems, and even baby monitors. Most of these applications are hard wired monitoring systems or they are short range wireless systems that include a fixed support infrastructure. Systems comprising long range surveillance and a mobile control infrastructure capable of autonomous operation that are cost effective for wide spread utilization remain a challenge.

Currently, unmanned aerial vehicles and unmanned land vehicles use one of two systems. One system is comprised of a satellite controlled system that requires a manned ground control station including large vehicles and heavy equipment. In such a system the ground station collects video, manipulates the data for long range communication and distributes the video by establishing a satellite communication link. Once the satellite link is established, the satellite can redirect the information to any location capable of receiving satellite data. With one or more satellite overhead at any one time, the unmanned vehicle can transmit uninterrupted video of its operation to anyone in the world capable of receiving satellite communications. Direct TV and many Department of Defense surveillance systems utilize this approach, albeit without the capability of surveillance captured by an unmanned vehicle.

A second approach as would be known to one of reasonable skill in the art is to use a very directional, line-of-sight system to command and control an unmanned vehicle and to provide a single stream of video. The line-of-sight system provides a single down-link to a single monitor. Unfortunately, this type of system is limited in range and bandwidth. While effective in narrow applications, the functionality gained from this approach comes at the cost of flexibility and versatility.

While many of the wireless systems are effective in narrow instances they lack the ability to react to a changing environment. Cellular communications systems are non-functional without a wide array of fixed base stations and a comprehensive mobile switching center for cell/call management. Satellite communication schemes are not only expensive but rely on the ability to use overhead satellite resources which are in limited supply. A challenge remains to combine the advantages of these existing systems while eliminating their deficiencies so as to produce a wireless surveillance and communication system that does not rely on existing infrastructure, is mobile and can provide seamless streaming video and communication to a plurality of subscribers. This and other challenges of the prior art are addressed by one or more embodiments of the present invention.

### SUMMARY OF THE INVENTION

Generally, the present invention embodies a portable and autonomous wireless communication system operable to distribute streaming video from a data collection source such as an Unmanned Aerial Vehicle (UAV), Unmanned Land Vehicle (ULV) or Unmanned Maritime Vessel (UMV) platform(s). According to one embodiment of the present invention live streaming video is provided over a wireless communication system using the Internet allowing video and other data to be routed to multiple subscribers. Video can be received by devices (subscribers) located within a mobile command vehicle, other mobile ground or maritime units, handheld devices, or other stationary or mobile monitors within a primary wireless network or conveyed via the Internet and rebroadcast on a secondary wireless network. Embodiments of the present invention further provide command and control of unmanned vehicles and can provide manned mobile units with secure VOIP communications. In one embodiment the present invention uses an IP tunneling mechanism to interface with the auto-pilot of the unmanned platforms. Each of these network systems can be established and maintained without any existing infrastructure.

According to one or more embodiments of the present invention, a 360 degree, Omni-directional, IP based, cloud network is established for each data collection resource rather than a single line of sight analog system as is known in the prior art. The system of the present invention enables the use of other IP devices such as portable/stationary camera, VOIP, etc. in the network at the same time and can be transported to an event site and established without utilization of any existing infrastructure. Thus one embodiment of the present invention provides a means to quickly establish an IP based network so as to send a data stream to a plurality of recipients on a computer network. Current systems provide for only a single video downlink to one monitor or are infrastructure intensive. Accordingly, video from a data collection resource such as a UAV, ULV or UMV can, according to one embodiment of the present invention, be streamed to multiple monitors simultaneously.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows top and side view of a network environment of an Internet based, partitioning wireless network;

FIG. 2 shows two overlapping cells of a partitioning wireless network and Internet interface according to one embodiment of the present invention;

FIG. 3 is a high level block diagram of system components for an Internet based, partitioning wireless network according to one embodiment of the present invention; and

FIG. 4 is a flowchart of a method for providing an Internet based, partitioning wireless network according to one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### GLOSSARY OF TERMS

As a convenience in describing the invention herein, the following glossary of terms is provided. Because of the introductory and summary nature of this glossary, these terms must also be interpreted more precisely by the context of the Detailed Description in which they are discussed.

Wi-Max (also referred to as WiMAX), meaning Worldwide Interoperability for Microwave Access, is a telecommunications technology that provides wireless transmission of data using a variety of transmission modes, from point-to-multipoint links to portable and fully mobile internet access. The technology is based on the 802.16 standard (also called Broadband Wireless Access being developed by the IEEE to provide a wireless coverage of up to 31 miles. Wi-Max operates in the 2 to 11 GHz bands and enables connectivity without a direct line-of-sight to a base station although line-of-site may be required to achieve connectivity at the distance of 31 miles

Wi-Fi is a trademark of the Wi-Fi Alliance that manufacturers can use to brand certified products that belong to a class of Wireless Local Area Network (WLAN) devices based on the IEEE 802.11 standards. The 802.11 standard is the most widely used WLAN technology today. Because of the close relationship with the underlying standards, the term Wi-Fi is often used as a synonym for IEEE 802.11 technology. Wi-Fi allows an individual to interconnect a computer, PDA or other devices—all without the expense of cumbersome cables. Wi-Fi networks use radio technologies called IEEE 802.11a, 802.11b or 802.11g (802.11n is currently under final development) to provide secure, reliable, fast wireless connectivity. Wi-Fi networks operate in the unlicensed 2.4 and 5 GHz radio bands, with an 11 Mbps (802.11b) or 54 Mbps (802.11a) data rate or with products that contain both bands (dual band). They can provide real-world performance similar to the basic 10BaseT wired Ethernet networks.

PCS refers to a Partitioning Communication System (PCS). PCS is a high-assurance computer security architecture based on an information flow separation policy. The PCS extends the four foundational security policies of a MILS (Multiple Independent Levels of Security) separation kernel to the network including end-to-end information flow, end-to-end data isolation, end-to-end periods processing, and end-to-end damage limitation. PCS leverages the separation kernel to enable application layer entities to enforce, manage and control application layer security policies in such a manner that the application layer policies cannot be bypassed, can be evaluated, are always invoked and are tamper resistant.

Cloud Computing is a paradigm of computing in which dynamically scalable and often virtualized resources are provided as a service over the Internet. Users need not have knowledge of, expertise in, or control over the technology infrastructure in the “cloud” that supports them. The term cloudy is used as a metaphor for the Internet, based on how the Internet is depicted in computer network diagrams and is an abstraction for the complex infrastructure it conceals.

Streaming Video includes multimedia that is constantly received by, and normally presented to, an end-user and is delivered by a streaming provider (the term “presented” is used in this article in a general sense that includes audio or video playback). The name refers to the delivery method of the medium rather than to the medium itself. The distinction is usually applied to media that are distributed over telecommunications networks, as most other delivery systems are either inherently streaming (e.g., radio, television) or inherently non-streaming (e.g., books, video cassettes, audio CDs).

HyperText Transfer Protocol (HTTP) is a communications protocol for the transfer of information on the Internet or a similar wide area network. HTTP is a request/response standard between a client and a server. A client is the end-user; the server is the web site. The client making a HTTP request—using a web browser, spider, or other end-user tool—is referred to as the user agent. The responding server—which stores or creates resources such as Hypertext Markup Language (HTML) files and images—is called the origin server. In between the user agent and the origin server may be several intermediaries, such as proxies, gateways, and tunnels. HTTP is not constrained to using TCP/IP and its supporting layers, but HTTP is the most popular communication protocol application on the Internet.

A Web Server is a computer housing a computer program that is responsible for accepting HTTP requests from web clients, which are known as web browsers, and serving them HTTP responses along with optional data contents, which usually are web pages such as HTML documents and linked objects (images, etc.).

Internet Protocol (IP) is a protocol used for communicating data across a packet-switched internetwork using the Internet Protocol Suite, also referred to as TCP/IP. The Internet Protocol Suite is the set of communications protocols used for the Internet and other similar networks. It is named from two of the most important protocols in it: the Transmission Control Protocol (TCP) and the Internet Protocol (IP), which were the first two networking protocols defined in this standard. Today's IP networking represents a synthesis of several developments that began to evolve in the 1960s and 1970s, namely the Internet and LANs (Local Area Networks), which emerged in the mid- to late-1980s, together with the advent of the World Wide Web in the early 1990s. The Internet Protocol Suite, like many protocol suites, may be viewed as a set of layers. Each layer solves a set of problems involving the transmission of data, and provides a well-defined service to the upper layer protocols based on using services from some lower layers. Upper layers are logically closer to the user and deal with more abstract data, relying on lower layer protocols to translate data into forms that can eventually be physically transmitted. The TCP/IP model consists of four layers (RFC 1122). From lowest to highest, these are the Link Layer, the Internet Layer, the Transport Layer, and the Application Layer.

The Internet is a global system of interconnected computer networks that use the standardized Internet Protocol Suite, serving billions of users worldwide. It is a network of networks that consists of millions of private, public, academic, business, and government networks of local to global scope that are linked by copper wires, fiber-optic cables, wireless connections, and other technologies. The Internet carries a vast array of information resources and services, most notably the inter-linked hypertext documents of the World Wide Web and the infrastructure to support electronic mail. In addition, it supports popular services such as online chat, file transfer and file sharing, gaming, commerce, social networking, publishing, video on demand, teleconferencing and telecommunications.

Wireless communication is the transfer of information over a distance without the use of electrical conductors or “wires”. The distances involved may be short (a few meters as in television remote control) or long (thousands or millions of kilometers for radio communications). When the context is clear, the term is often shortened to “wireless”. Wireless communication is generally considered to be a branch of telecommunications.

A Router is a networking device whose software and hardware are usually tailored to the tasks of routing and forwarding information. For example, on the Internet, information is directed to various paths by routers. A router is a network device that forwards packets from one network to another. Based on internal routing tables, routers read each incoming packet and decide how to forward it. The destination address in the packets determines which line (interface) outgoing packets are directed to. In large-scale enterprise routers, the current traffic load, congestion, line costs and other factors determine to which line data is forwarded.

A network switch or switching hub is a computer networking device that connects network segments. The term commonly refers to a network bridge that processes and routes data at the data link layer. Switches that additionally process data at the network layer (layer 3 and above) are often referred to as Layer 3 switches or multilayer switches. The term network switch does not generally encompass unintelligent or passive network devices such as hubs and repeaters. The network switch, packet switch (or just switch) plays an integral part in most Ethernet local area networks or LANs. Mid-to-large sized LANs contain a number of linked managed switches. Small office/home office applications typically use a single switch, or an all-purpose converged device such as a gateway to access small office/home broadband services such as DSL or cable internet. In most of these cases, the end-user device contains a router and components that interface to the particular physical broadband technology, as in Linksys 8-port and 48-port devices.

### DESCRIPTION OF THE INVENTION

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

Wireless communication and data transfer in a situation or environment where physical infrastructure or monitoring is not possible or practical can be provided by a wireless communication system utilizing PCS technology according to one or more embodiments of the present invention. By implementing a robust system of communication links, mobile infrastructure communication paths can be easily established between unmanned surveillance vehicles, ground stations and/or subscriber units. Utilizing cloud communication techniques one or more embodiments of the present invention enable command-and-control signals to be relayed to and from unmanned area vehicles and unmanned land vehicles so as to provide streaming video to multiple end users in an environment in which typical ground into structure associated with wireless communication is either absent, damaged or inoperative.

According to one embodiment of the present invention a Wi-Max base station or station employing similar technology can be installed in an existing or new command center and incorporates antenna and equipment necessary for the distribution of data and communication signals to multiple fixed or mobile monitors within a specific geographical region. By utilizing the plurality of self-contained mobile devices possessing similar antenna and communication technology of the command center a series of overlapping network clouds can be created to indefinitely extend the reach of the communication system. These self-contained mobile devices and the centralized command station, which itself can be a mobile device, can be placed in an area otherwise lacking network infrastructure or can move according to the dynamic nature of the communication demands.

Each mobile device can create a 360°, Omni-directional network cloud for streaming video and other command-and-control signals and can operate autonomously or in concert with other network cells. Data down-linked from an unmanned vehicle can, in one embodiment of the present invention, be received by any one of the mobile devices or the command center and broadcast to an unlimited number of subscribers within any one of the linked network clouds. Moreover the entire network can be dynamically relocated as the demands of this scenario or the environment dictate.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a network subscriber” includes reference to one or more of such subscribers.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Included in the description are one or more flowcharts depicting examples of the methodology which may be used to provide an autonomous mobile wireless network. In the following description, it will be understood that one or more blocks of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

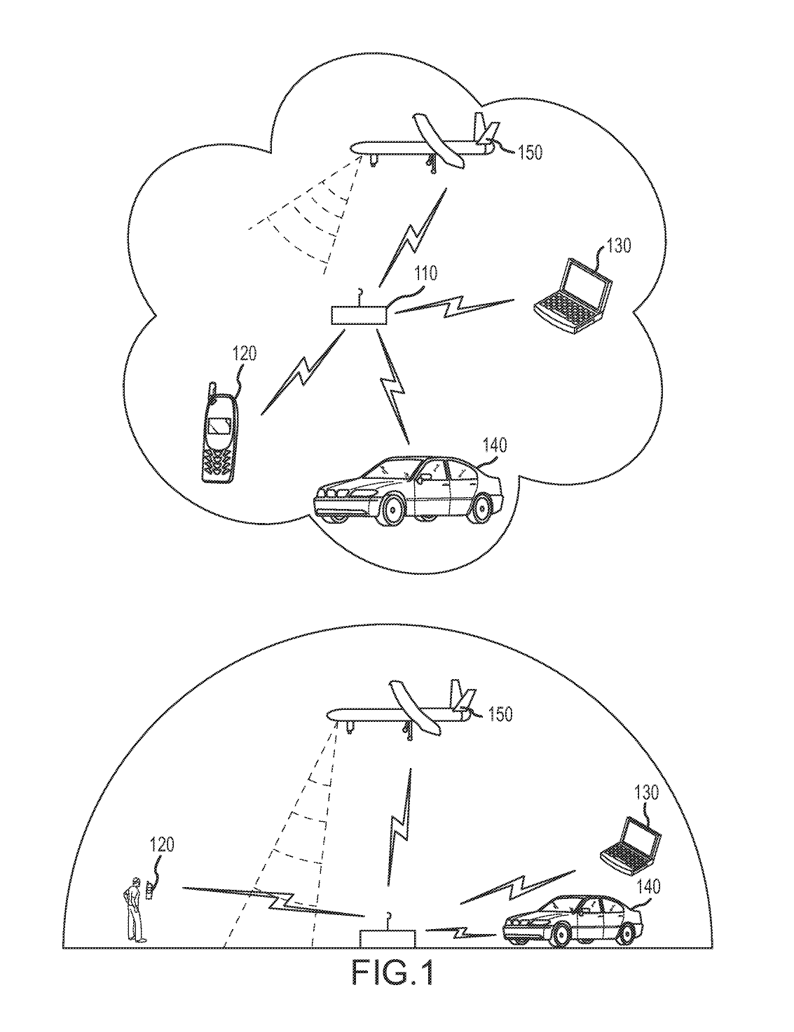

According to one embodiment of the present invention, and as shown in FIG. 1, a control station 110 (also referred to herein as a mobile ground station) establishes a wireless communication network 100 within which subscriber units can wirelessly communicate and gain data. FIG. 1 shows a plan form (top) and a side view of a wireless network 100 in which three subscriber units 120, 130, 140, UAV 150 and a control station 110 operate. The UAV 150 flying overhead includes a video capture device, among other things, that collects video and streams it back to the control station 110. While the data collection resource associated with the present invention is generally described with reference to an UAV, one skilled in the art will recognize that a data collection resource can be associated with many different platforms such as a ULV, UMV and the like. Where the data collection resource is referred to singularly it is to be understood that such reference is inclusive of the other contemplated forms of data collection.

The control station 110 is operable to provide basic network infrastructure services that are necessary to provide users (subscribers) within its area of influence seamless access to data. The control center is also operable, in one embodiment of the present invention, to interface with the Internet to expand the distribution of collected data and to access commands issued remotely.

While it is envisioned the present invention will operate under a Microsoft Windows domain one skilled in the relevant art will recognize that features of the present invention described herein can be implemented on any comparable operating computer system. In this respect the control center 110 can communicate with the UAV/ULV/UMV using a variety of established wireless networks or using Internet protocols.

The control center 110 is also operable to interface VOIP calls with standard wireless communication links enabling voice communication to subscriber units, 120, 130, 140 from locations distant from the operating environment. Streaming video captured by the UAV 150 can be captured and retransmitted live to participating subscriber units within the regional network. Moreover the data can be relayed to other cell control centers for similar transmission within their regional area.

Among other things the control center or mobile devices acting as a control center would include an antenna, an Internet modem or other Internet access capability, switching equipment, security and encryption algorithms, a file server and an exchange server. Each control station is autonomous and is capable of mobile operations.

The control station 110 maintains awareness of the subscriber units within its regional network; in this case a hand held unit 120, a laptop computer 130, and a vehicular unit 140. Each of these subscriber units 120, 130, 140 communicates independently with the base station and as information becomes available from the UAV 150, the control station 110 processes the data and makes it available. Any subscriber 120, 130 with the appropriate credentials and equipment can receive and view the data. According to another embodiment of the present invention information from the UAV 150, is broadcast throughout the wireless network is communicated to one or more subscribers 120,130 by demand. Rather than broadcasting the streaming video, the content of the video can be coded so as to be associated with one or more subscribers making the data not available to other, unauthorized subscribers. The encryption or transmissions of wireless data via a secure link is well known in the art and is not discussed further with respect to the present invention. One skilled in the encryption arts will appreciate that data of various forms including streaming video can be encrypted in such a manner to provide secure yet selective circulation of the data.

A typical cellular network employing 3G technology or the like can theoretically provide data rates up to 56 Mbit/s in the downlink mode and 28 Mbit/s in the uplink mode. While this sort of bandwidth and versatility is adequate for cellular communication it does not meet the demand of data intensive streaming video utilized by a large number of subscribers. One or more embodiments of the present invention utilize Wi-Max or Worldwide Interoperability for Microwave Access technology. The mobile Wi-Max (IEEE 802.16e-2005) mobile wireless broadband access standard offers peak data rates of approximately 128 Mbit/s downlink and 56 Mbit/s uplink over 20 MHz wide channels. The IEEE 802.16m evolution of 802.16e is projected to provide 1 Gbit/s for stationary reception and 100 Mbit/s for mobile reception. By utilizing the bandwidth offered by Wi-Max and follow-on technologies the present invention is able to provide real time streaming video to a plurality of subscribers simultaneously in an environment that would otherwise be void of any wireless communication capability.

The present invention can also be implemented using the related technology of Wi-Fi. A Wi-Fi enabled device such as a personal computer, video game console, smart phone or digital audio player can connect to the Internet when within range of a wireless network connected to the Internet. Typical Wi-Fi networks have limited range. A wireless router using 802.11b or 802.11g technology with a stock antenna can have a range of as little as 32 m (120 ft) indoors and 95 m (300 ft) outdoors. The IEEE 802.11n version of Wi-Fi, sometimes called Long-Range Wi-Fi, can exceed that range significantly. In long-range Wi-Fi, special technologies are used to optimize a Wi-Fi connection. The 802.11-2007 standard adds 10 MHz and 5 MHz OFDM modes to the 802.11a standard, and extends the time of cyclic prefix protection from 0.8 μs to 3.2 μs, quadrupling the multipath distortion protection.

Range also varies with frequency band. Wi-Fi in the 2.4 GHz frequency block has slightly better range than Wi-Fi in the 5 GHz frequency block. Outdoor ranges—through use of directional antennas—can be improved with antennas located several kilometers or more from their base.

Due to the complex nature of radio propagation at typical Wi-Fi frequencies, particularly the effects of signal reflection off trees and buildings, algorithms can only approximately predict Wi-Fi signal strength for any given area in relation to a transmitter. This effect does not apply equally to long-range Wi-Fi, since longer links typically operate from towers that broadcast above the surrounding foliage. Wi-Fi and Wi-Max can coexist and become increasingly complementary technologies for their respective applications. Wi-Fi technology is designed and optimized for Local Area Networks, whereas Wi-Max was designed and optimized for Metropolitan Area Networks (MAN). Wi-Max typically is not thought of as a replacement for Wi-Fi. Rather, Wi-Max complements Wi-Fi by extending its reach and providing a “Wi-Fi like” user experience on a larger geographical scale. According to one embodiment of the present invention each subscriber unit can create and manage a Wi-Fi network for local use. Information gained from the mobile control unit streamed to the subscriber via Wi-Max technology can then be redistributed via a Wi-Fi set up. By doing so local receiving units can be minimized to possess only the necessary equipment to receive and transmit data for short range operations while the mobile subscriber can possess the necessary Wi-Max equipment.

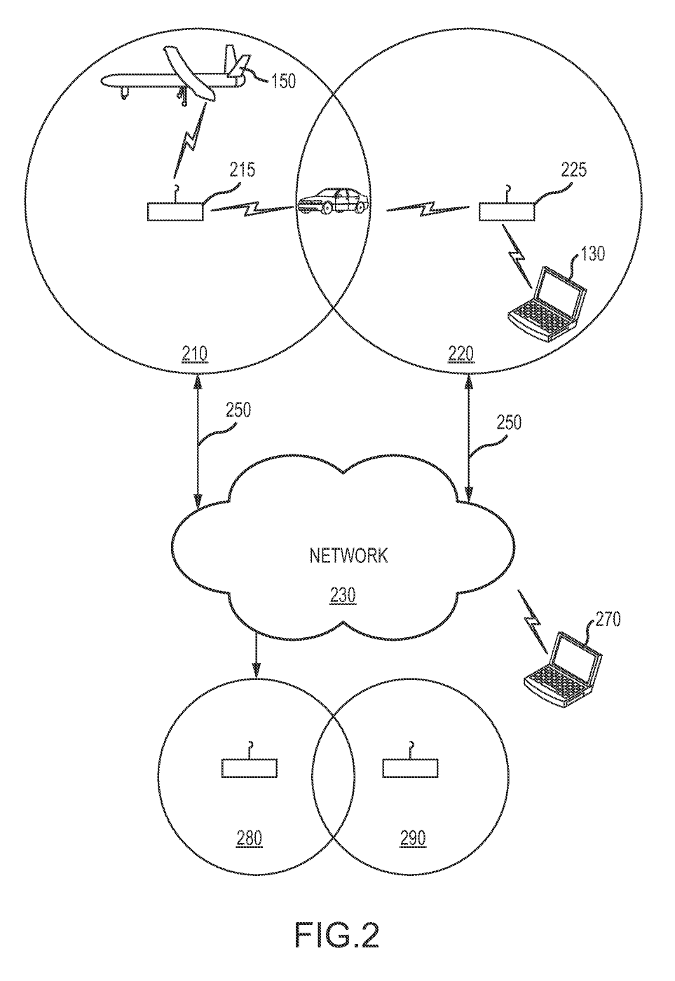

Another aspect of the present invention is the system's ability to form a mesh network of overlapping cells and to interface with the Internet. FIG. 2 is a high level view of two overlapping wireless local area networks (LANs) that interface with an existing wide area network (WAN) such as the Internet. Each LAN 210, 230 include a control station 215, 225 and a plurality of subscribers 260, 130. Within the first LAN 210 a UAV 150 operates to collect video and stream images to the control station 215 for processing the data. A subscriber 260 within the network 210 can directly request and receive the video from the base station 215.

Also shown in FIG. 2 is a second subscriber 130 positioned outside of the LAN 210 in which the images are captured. According to one embodiment of the present invention, each control station or mobile control device 215, 225 can access a WAN 230 such as the Internet to gain control and/or data managed by another control station. Thus each subscriber within each LAN has immediate access to data found in each other LAN. Upon gaining access to the Internet, a link between the two respective base stations 215, 225 can be established for secure data transfer.

The Internet is a collection of disparate computers and networks coupled together by a web of interconnections using standardized communications protocols. While most Internet access is currently performed using conventional personal computers and workstations, the variety of devices that access the Internet continues to grow. A major segment of growth is in the area of lightweight computing appliances. Examples include wireless telephones, personal digital assistants (PDAs), (referred to herein collectedly as subscribers) among other examples. These devices are characterized by little or no mass storage capability. In such devices there is increased need to access external mass storage such as network storage devices to access information needed to perform their functions.

The Internet is also characterized by its vast reach as a result of its wide and increasing availability and easy access protocols. Unfortunately, the ubiquitous nature of the Internet results in variable bandwidth and quality of service between points. The latency and reliability of data transport is largely determined by the total amount of traffic on the Internet and so varies wildly seasonally and throughout the day. Other factors that affect quality of service include equipment outages and line degradation that force packets to be rerouted, damaged and/or dropped. Also, routing software and hardware limitations within the Internet infrastructure may create bandwidth bottlenecks even when the mechanisms are operating within specifications.

With the advent of the Internet, computing appliances that can potentially act as interfaces to a database or data source have potentially ubiquitous access to this information. The Internet enables ready access from a wide variety of computing appliances at numerous locations.

According to one embodiment of the present invention, a secondary control station 225 maintains knowledge of data available from each other control station within the network. Upon receiving a request for the video or similar data, the control station determines whether the subscriber providing the sought after data 150 is present within its own network. If the provider of the data is within the wireless network, the base station can act autonomously to provide the subscriber (assuming credentials are validated) with the requested data.

When the control station 225 determines that the requested data is not within its own network 220, it can communicate with other control stations 210 of the wireless network either directly, by relay or via a WAN 230 to gain access to the data. In the example illustrated in FIG. 2, a subscriber 130 communicates to a base station 225 which does not possess a direct link to the UAV 150 nor to the control station 215 interfacing with the UAV 150. Having access 250 to the WAN 230, the base station conveys its request for data to the control station 215 in whose network the UAV 150 is operating. Data from the UAV 150 is thereafter relayed from the first control station 215 to the Internet 230 and thereafter to the second base station 225. From there the data is conveyed to the requesting subscriber 130.

Each control station within an existing wireless network of multiple cells communicates with one another to determine where a particular resource is located. As one skilled in the relevant art will recognize, a wireless network may comprise a plurality of overlapping cells. Indeed it is contemplated by the present invention that one or more cells can be part of a wireless network yet be geographically or physically distinct from a set of overlapping cells in which the UAV or data collection device is operating. For example, a UAV 150 may be operating in a combat zone or urban environment and a second wireless network (cell) 280, 290 may be at a secure location yet linked to the collection efforts via the Internet 230. By doing so the communication system is partitioned using the Internet or other WAN as the connectivity medium between various cells and subscribers.

Another aspect of the present invention is the ability of not only the subscribers to move freely within each LAN and between various LANs, but also that the control centers themselves are dynamic and that the topology of the entire meshed or overlapped network is dynamic. As the control stations move the interactions between the various control stations and the subscribers within each LAN must adjust so as to maintain their respective relationship and control of their respective LAN. Moreover new control stations and subscribers may be added to the overall network and existing control stations and subscribers deleted. Similarly data collection resources such as UAV/ULV/UMVs may traverse several LANs while collecting and streaming data. As the UAV/ULV/UMV or collection resource moves from one control station to the next a handoff of control methodology is accomplished. By doing so the streaming data from the UAV/ULV/UMV is uninterrupted as it merely is transmitted to a new receiver. According to one embodiment of the present invention control signals for management and processing of the collected data can remain at a single control station and be conveyed to the UAV/ULV/UMV via another control center. It is also contemplated that actual control of the UAV/ULV/UMV may be remote from the actual operating environment and sent to the control centers via IP messaging on the Internet (WAN).

To enhance the robustness of the network associated with the present invention each control system can operate autonomously as well as use subscribers present in an overlapping region of the various LANs to act as a conduit for data. According to one embodiment of the present invention, a subscriber 260, which resides in an overlapping portion 265 of the two overlapping cells, can relay data and control information to adjacent base stations. In the present example, the subscriber 260 in the overlapping region 265 would be in primary communication with only one base station. The determination of which control station a subscriber would be primarily affiliated with and the handoff between the two stations is well known to one skilled in the relevant art. While only one base station is directly linked to the subscriber 260, it resides on each base station's 215, 225 list of subscribers within its LAN. According to one embodiment of the present invention the base station receiving the request for data from the UAV 150 from a subscriber 130 is aware that another subscriber 260 is in a position to relay the data. Rather than communicating via the Internet 230 or if a WAN 230 connection is unavailable, communications can be conveyed between the two base stations 215, 225 via the common subscriber 260. Using the common subscriber as a bridge, data collected by the UAV 150 can be transmitted to the requesting subscriber 130. Furthermore, the transmission of data can be transparent to the subscriber 260 residing in the overlapping region 265. By having multiple subscribers in various overlapping region in a mesh network, data collected and streamed to one control center can be conveyed throughout the overall network and to each requesting subscriber without having access to a bridge WAN.

As was previously mentioned, one aspect of the present invention is to place and operate a robust wireless communication system in an environment in which such a system is either absent or is inoperable. In many circumstances the area of focus in such an environment is an event that is mobile but the region of interest surrounding that event is relatively stable. All subscribers working on a particular event would likely remain within the area of interest even though that area of interest is moving. As the area of interest moves, all subscribers within that cell can immediately access data collected by the UAV or other subscribers. Intermediary routing is unnecessary, resulting in improved efficiency and decreased latency.

To better understand the implementation and novel features of the present invention consider the following example. An event has taken place in which law enforcement and other agencies are responding to offer assistance. For one or more reasons there is no current wireless service in the area or the service is unreliable. Moreover, first responding agencies utilizing a normal network would be competing for bandwidth with non-responders which could significantly hamper the transmission data, especially streaming video. A local wireless network is established using a mobile control center or station wherein each responder is registered as a subscriber within that network. The area of interest however is not stationary and indeed as more data is gained becomes mobile. Under one embodiment of the present invention multiple control stations can be established to form a mesh network and thus facilitate the mobility of the event and provide each subscriber with an uninterrupted source of data (video). According to another embodiment of the invention the control station responsible for receiving and distributing data collected by the subscribers including the UAV/ULV/UMV moves with the event. While the processing time and delay for data to be exchanged between multiple control centers to ultimately arrive at a subscriber is minimal, even that delay and processing can be eliminated by maintaining a direct link between the control center receiving the data from the UAV/ULV/UMV and the requesting subscriber. By moving the control center to mirror the needs of the subscriber's data transmissions can be optimized.

An additional feature of the present invention is to locate the control station's attributes within the UAV/ULV/UMV itself. As the UAV/ULV/UMV is likely to remain centered around an event of interest the primary LAN would be assured to be accessible to all interested parties.

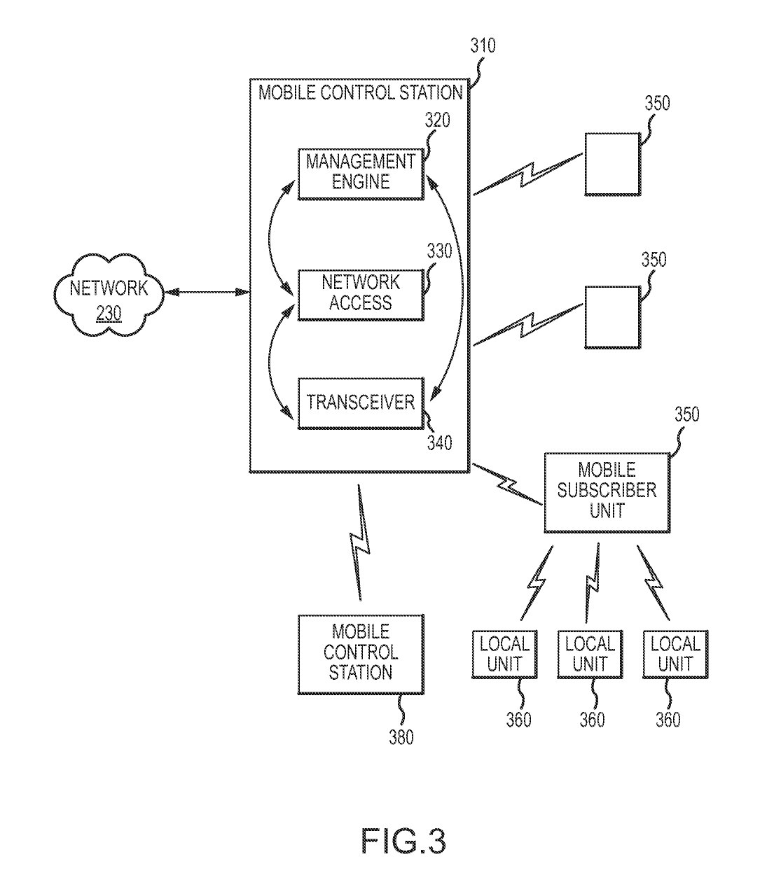

FIG. 3 is a high level block diagram of a plurality of subscribers and a control station found in a wireless network according to one embodiment of the present invention. Each subscriber 350 includes the ability to wirelessly link with the control station 310 as well as to, in one embodiment, local units 360. The control station 310 is interposed between the plurality of subscribers 350 and a wide area network 230 such as the Internet. It is also possible that the primary control station 310 can communicate to a neighboring control station 380 either directly or through a relay. In other embodiments the network can be a local area network with limited access.

The control station 310 further comprises a management engine 320, a network access engine 330 and a transceiver 340. As one skilled in the art of wireless communication will appreciate the control station 310 depicted in FIG. 3 may include other components common in wireless technology beyond those shown. These include antenna, firewall and security modules, an Internet modem or similar means to connect to the Internet, switching equipment, power and environmental conditioning equipment, various storage media, file servers and application servers, a domain controller and system management/server management systems.

As data is collected by the plurality of subscribers 350 including for example a UAV/ULV/UMV and conveyed to the control station 310, the management engine 320 parses the data and determines whether a request for the data has been received. If a request from a participating subscriber 350 or another control station exists and the data is present within the control station 310, the management engine 320 directs the data to the requesting subscriber 350/requesting control station. The management engine also manages bandwidth requirements and limitations. Should the number of requests exceed the capability of the transceiver 340, those requests associated with a higher priority are serviced first. The priority scheme can be based on pre-established criteria or other means as would be known to one skilled in the relevant art.

The base station 310 further includes a network access component 330, which establishes access to a wide area network such as the Internet. Through this access point, a link can be established to other base stations and other subscribers within each of the wireless networks surrounding those base stations. According to one embodiment of the present invention the control station, and specifically the network access engine 330, can include a web server which can post the data collected by one of the subscribers 350 on a website on the Internet. From there the data can be viewed by subscribers possessing the proper access credentials and equipment.

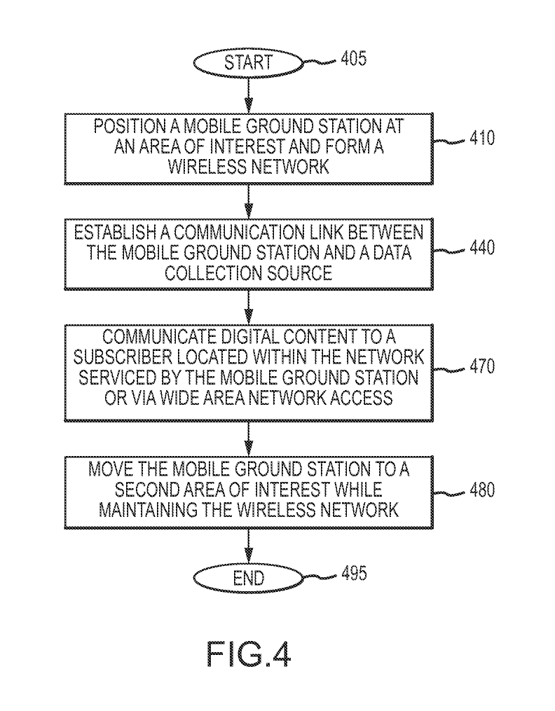

FIG. 4 depicts a flowchart of a method for providing an Internet based partitioned wireless communication system. According to one embodiment of the present invention such a wireless communication system can be established in an environment void of any wireless network infrastructure by positioning 410 a mobile ground station in an area of interest. The mobile ground station, or control station as it is also referred to herein, can comprise equipment mounted in a vehicle, trailer, or be man portable.

Having created a wireless network surrounding a mobile ground station, a communication link is thereafter established 440 between the mobile ground station and a data collection source such as a UAV, ULV or UMV. While the present invention has been generally described with data collection in the form of streaming video gained by an UAV/ULV/UMV, other forms of data and other forms of data collection platforms are equally compatible with the present invention. Indeed the present invention has wide applicability beyond simple surveillance, all of which are contemplated and considered to be within the scope of the present invention.

Data collected by a resource such as a UAV, ULV or UMV is processed and sent to the mobile ground station where it is distributed or communicated 470 to one or more subscribers within the area network. When data is requested by subscribers outside of the network region served by the collecting mobile ground station, the data can be conveyed to the requesting subscriber via one or more relays or subscribers who are located in overlapping regions of various network cells or via the Internet. When multiple mobile ground stations act as access points to the Internet the collected data can be conveyed to various requesting subscribers via the Internet using Internet Protocols. The data is digitized and sent via packets to another base station where it is rebroadcast to the requesting subscriber. In that way the cell collecting the data does not necessarily have to overlap with the cell supporting the requesting subscriber.

In situations where multiple mobile ground stations have not been established or their presence is not feasible, the location of the existing mobile ground station supporting the wireless network can move 480 to match the movement of the event of interest. While doing so the mobile ground station maintains its link with the surveillance resource as well as communication links with the plurality of subscribers within its network area of control.

In a preferred embodiment, portions of the present invention can be implemented in software. Software programming code, which embodies portions of the present invention, is typically accessed by a microprocessor from long-term, persistent storage media of some type, such as a flash drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory or on physical media and/or for distributing software code via networks are well known and will not be further discussed herein.

Generally, program modules include routines, engines, programs, objects, components, data structures and the like that perform particular tasks or implement particular abstract data types. Moreover, those skilled in the art will appreciate that the invention can be practiced with other computer system configurations, including handheld devices, multi-processor systems, microprocessor-based or programmable consumer electronics, network PCs, minicomputers, mainframe computers and the like. The invention may also be practiced in distributed computing environments where tasks are performed by remote processing devices that are linked, either wirelessly or wired, through a communications network or a Wide Area Network such as the Internet. In a distributed computing environment, program modules may be located in both local and remote memory storage devices.

An exemplary system for implementing the invention includes a general purpose computing device, a communication device or the like, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The computer may further include a hard disk drive for reading from and writing to a hard disk and/or a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer, such as magnetic cassettes, flash memory cards, digital video disks, random access memories (RAMs), read-only memories (ROMs) and the like, may also be used in the exemplary operating environment.

Program modules may be stored on the hard disk, magnetic disk, ROM or RAM, including an operating system, one or more application programs or software portions, other program modules and program data. A user may enter commands and information into the computer through input devices such as a keyboard and/or pointing device. Other input devices may include a camera, microphone, satellite dish, scanner or the like. These and other input devices are often connected to the processing unit through a serial port interface that is coupled to the system bus, but may be connected by other interfaces, such as a parallel port, game port or universal serial bus (USB). A monitor or other type of display device may also be connected to the system bus via an interface, such as a video adapter.

A computer used in concert with the present invention may operate in a networked environment as described herein using logical connections to one or more remote computers. The remote computer may be another computer, a server, a router, a network PC, a peer device or other common network node, and typically includes many or all of the elements described above relative to the personal computer. The logical connections described herein include Local Area Networks (LAN) and wide area networks (WAN). Such networking environments are commonplace in enterprise-wide computer networks, Intranets and the Internet.

When used in a LAN networking environment, a computer associated with the present invention is connected to the local network through a network interface or adapter. When used in a WAN networking environment, the computer typically includes a means for establishing communications over the wide area network, such as the Internet, and become an access point. This means is typically connected to the system bus via the serial port interface. It will be appreciated that the network connections shown are exemplary and other means of establishing a communications link between the computers may be used.

The various communication subscriber apparatus described in the present invention are illustrative of various wireless devices including, for example, mobile and cellular phone handsets, machine-to-machine (M2M) communication networks (e.g., wireless communications for vending machines), so-called “911 phones” (a mobile handset configured for calling the 911 emergency response service), as well as devices employed in emerging applications such as 3G, 4G, 802.11n, satellite communications, and the like. As such, wireless communication apparatus may provide RF reception functionality, RF transmission functionality, or both (i.e., RF transceiver functionality).

The subscriber units of the present invention may be configured to implement one or more specific communication protocols or standards including those described in 802.11, (e.g. 802.11n) as desired. While it is contemplated that the present invention will utilize Wi-Max or Wi-Fi technology, other wireless communication technology is equally compatible with the present invention. For example, in various embodiments communication apparatus may employ a Time-Division Multiple Access (TDMA) standard or a Code Division Multiple Access (CDMA) standard to implement a standard such as the Global System for Mobile Communications (GSM) standard, the Personal Communications Service (PCS) standard, and the Digital Cellular System (DCS) standard. In addition, many data transfer standards that work cooperatively with the GSM technology platform may also be supported. For example, communication apparatus may also implement the General Packet Radio Service (GPRS) standard, the Enhanced Data for GSM Evolution (EDGE) standard, which may include Enhanced General Packet Radio Service standard (E-GPRS) and Enhanced Circuit Switched Data (ECSD), and the high speed circuit switched data (HSCSD) standard, among others.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three.

Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming Additionally, the present invention is in no way limited to implementation in any specific programming language, or for any specific operating system or environment. And while there have been described above the principles of the present invention in conjunction with an Internet based partitioned wireless communication network, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein.

Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A mobile system for wireless delivery of digital content with a plurality of users comprising:
a vehicle operable for simultaneous transmission and reception of digital content;
a mobile ground station in communication with the aerial vehicle wherein the mobile ground station is associated with a ground wireless area network; and
at least one subscriber unit within the ground wireless area network and in communication with the mobile ground station operable to receive digital content from the vehicle via the mobile ground station.

2. The mobile system of claim 1 wherein the vehicle is an unmanned aerial vehicle.

3. The mobile system of claim 1 wherein digital content includes streaming video.

4. The mobile system of claim 1 wherein the mobile ground station is an Internet access point.

5. The mobile system of claim 4 wherein digital content transmitted from the vehicle to the mobile ground station can be transmitted to a remote control station using Internet communication protocols.

6. The mobile system of claim 5 wherein the remote control station is operable to command and control operation of the vehicle.

7. The mobile system of claim 1 wherein communication between the at least one subscriber and the mobile ground station is not line-of-sight dependent.

8. The mobile system of claim 1 wherein the at least one subscriber unit is operable to receive digital content directly from the vehicle.

9. The mobile system of claim 1 wherein responsive to the at least one subscriber unit also being within a second ground wireless area network associated with a second mobile ground station, the subscriber unit is operable as a relay of digital content to a second mobile ground station.

10. The mobile system of claim 1 wherein communication between the vehicle, mobile ground station and at least one subscriber is based on a world-wide interoperability for microwave access (WI-MAX) standard.

11. The mobile system of claim 1 wherein communication between the vehicle, mobile ground station and at least one subscriber is based on the Institute of Electrical and Electronics Engineers 802.11n standard.

12. The mobile system of claim 1 wherein the mobile ground station is operable to command and control the vehicle.

13. The mobile system of claim 1 wherein transfer of digital content among the vehicle, the plurality of mobile ground stations and the at least one subscriber units is maintained during movement of the vehicle, the plurality of mobile ground stations and/or the at least one subscriber.

14. An autonomous and mobile wireless communication system comprising:
an aerial vehicle operable to collect and distribute digital; and
a plurality of overlapping ground wireless area networks wherein at least one ground wireless area network is communicatively linked to the aerial vehicle and wherein each ground wireless network is associated with one of a plurality of mobile ground stations.

15. The wireless communication system of claim 14 wherein digital content collected by the aerial vehicle is processed and managed for transmission by the aerial vehicle.

16. The wireless communication system of claim 14 wherein digital content collected by the aerial vehicle is processed and managed for transmission by the plurality of mobile ground stations.

17. The wireless communication system of claim 14 further comprising at least one subscriber unit associated with at least one of the plurality of mobile ground stations.

18. The wireless communication system of claim 17 wherein the at least one subscriber unit is associated with a land vehicle.

19. The wireless communication system of claim 17 wherein the at least one subscriber unit can be configured to be a mobile hot-spot.

20. The wireless communication system of claim 17 wherein communication between the aerial vehicle, the plurality of mobile ground stations and at least one subscriber is based on a world-wide interoperability for microwave access (WI-MAX) standard.

21. The wireless communication system of claim 14 wherein communication between the aerial vehicle, the plurality of mobile ground stations and at least one subscriber is independent of a line-of-sight communication link.

22. The wireless communication system of claim 17 wherein the at least one subscriber unit is operable to receive digital content collected by the aerial vehicle.

23. The wireless communication system of claim 22 wherein the digital content is delivered to the at least one subscriber unit via at least one mobile ground station.

24. The wireless communication system of claim 22 wherein the digital content is delivered to the at least one subscriber unit directly from the aerial vehicle.

25. The wireless communication system of claim 14 wherein at least one of the plurality of mobile ground stations is operable as an Internet access point.

26. The wireless communication system of claim 14 wherein communication among the aerial vehicle, the plurality of mobile ground stations and the at least one subscriber units is maintained during movement of any of the aerial vehicle, the plurality of mobile ground stations and/or the at least one subscriber unit.

27. A method for providing an autonomous mobile wireless network comprising:
positioning a first mobile ground station at a first area of interest wherein the mobile ground station is associated with a first ground wireless area network and at least one subscriber;
establishing a communication link between the mobile ground station and an aerial vehicle wherein the aerial vehicle is operable to collect and disseminate digital content to the mobile ground station; and
communicating digital content from the aerial vehicle to the at least one subscriber; and
moving the first mobile ground station and the aerial vehicle to a second area of interest while maintaining the first ground wireless area network.

28. The method according to claim 27 further comprising accessing the Internet at the mobile ground station.

29. The method according to claim 28 further comprising sending command and control messages from a remote site to the aerial vehicle using the Internet.

30. The method according to claim 27 further comprising establishing a communication link directly between the at least one subscriber and the aerial vehicle.

31. The method according to claim 27 further comprising controlling the aerial vehicle by transmitting from the mobile ground station command and control signals.

32. The method according to claim 27 wherein the at least one subscriber is within the ground wireless area network.

33. The method according to claim 27 wherein the at least one subscriber is within a second ground wireless area network associated with a second mobile base station.

34. The method according to claim 27 wherein communication between the aerial vehicle, the ground station and the at least one subscriber is based on a world-wide interoperability for microwave access (WI-MAX) standard.

35. The method according to claim 27 wherein communication between the aerial vehicle, the mobile ground station and the at least one subscriber is based on the Institute of Electrical and Electronics Engineers 802.11n standard.
